(19) United States
(12) Patent Application Publication
(10) Pub. No.: US 2016/0228885 A1
(43) Pub. Date: Aug. 11, 2016

(54) Water Outlet Structure for Generating Candle Flame Shaped Water and A Shower Head Mounting the Same

(71) Applicant: KYLIN Sanitary Technology (Xiamen) Co., Ltd., XIAMEN (CN)

(72) Inventors: Kyle William Cutler, XIAMEN (CN); Qingshuang Li, XIAMEN (CN); Xijie Deng, XIAMEN (CN); Hui Huang, XIAMEN (CN); Fuhui Zhong, XIAMEN (CN)

(73) Assignee: KYLIN Sanitary Technology (Xiamen) Co., Ltd., XIAMEN (CN)

(21) Appl. No.: 14/988,760

(22) Filed: Jan. 6, 2016

(30) Foreign Application Priority Data
Feb. 7, 2015 (CN) 201520091438.5

(51) Int. Cl. B05B 1/18; B05B 1/02

(52) U.S. Cl. CPC B05B 1/185; B05B 1/02

(57) ABSTRACT

A water outlet structure for generating candle flame shaped water and a shower head mounting the same comprises a water inlet passage to collecting water, a hemisphere water chamber formed at the bottom of the water inlet passage, a V shaped through groove set at the bottom of the hemisphere water chamber and an axis of the V shaped through groove located on an outside of the axis of the water inlet passage and forming a fixed angle. The water flows are concentrated and the water pressure is increased due to a mutation when the water flows through the intersection area between the hemisphere water chamber and the V shaped through groove, and by a further angle deviating, a much more intense collision effect is generated inside the channel. A larger area showering, favourable impact force, particle feeling and water saving are achieved.

### FIELD OF THE INVENTION

The present invention relates to a water owlet structure and a shower head mounting the same, and more specifically relates to water outlet structure for generating candle flame shaped water and a shower head mounting the same.

### BACKGROUND OF THE INVENTION

The existing shower device has a demanding need for the shape of the generated water, not only in the water-saving part, but also the higher requirement for the different feelings when the spray contacts with human body. The existing water outlet structure and the shower head mounting the above structure have the following disadvantages: the shape of the generated water is usually columnar or line shaped; the spraying is inhomogeneous and the pressure is not high enough, a favourable impact force and particle feeling cannot generated with the existing device.

### SUMMARY OF THE INVENTION

In order to overcome the drawbacks of the existing shower device, the present invention provides a water outlet structure for generating candle flame shaped water and a shower head mounting the same. With this special structure, a water flow concentration is generated, a favourable strong impact force and particle feeling can be generated due to a higher water pressure of this structure.

In order to achieve the above goals, the technical solution is as follow:

A water outlet structure for generating candle flame shaped water comprises a water inlet passage to collecting water, a hemisphere water chamber formed at the bottom of the water inlet passage, a V shaped through groove set at the bottom of the hemisphere water chamber, an axis of the V shaped through groove located on an outside of the axis of the water inlet passage and forming a fixed angle.

The fixed angle ranges from 5 to 15 degrees.

A shower head for generating candle flame shaped water, wherein a surface cover of the shower head is set with the above water outlet structure for generating candle flame shaped water thereon in a matrix form.

The shower head for generating candle flame shaped water, further comprises a head body and the surface, wherein the surface cover cooperates with the head body, Wherein the water inlet passage of the water outlet structure and the surface cover are molded in an integrated structure.

Adopting the above technical solution, the present invention speeds the water flows through the inlet passage having the water collecting function. The water flows are concentrated and the water pressure is increased due to a mutation when the water flows through the intersection area between the hemisphere water chamber and the V shaped through groove, and by a further angle deviating, a much more intense collision effect is generated inside the channel. After the collision, the water sprays onto the users' body, a larger area showering and more intense impact force and particle feeling are achieved. At the same time, the same effect is achieved by using much less water with above structure, which saves much water to some extent.

### BRIEF DESCRIPTION OF THE DRAWINGS

FIG. 1 is a schematic view of a water outlet structure of the present invention.

FIG. 2 is an exploded view of a shower head mounting the water outlet structure of the present invention.

FIG. 3 is a diagrammatic cross-section view of the shower head mounting the water outlet structure of the present invention.

FIG. 4 is a plan view of a panel of the shower head.

### DETAILED DESCRIPTION OF THE INVENTION

A detailed description of the present invention is presented with the accompanying drawings and the specific embodiment.

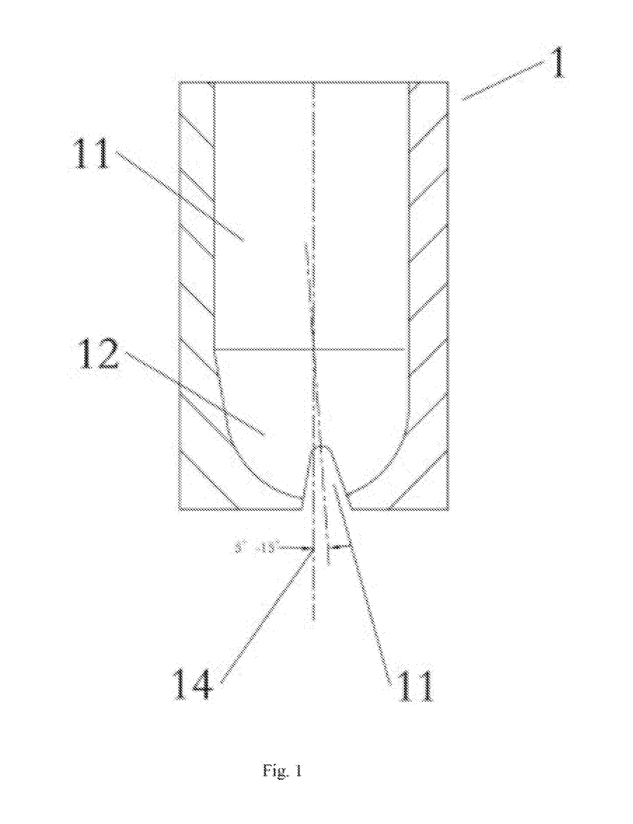

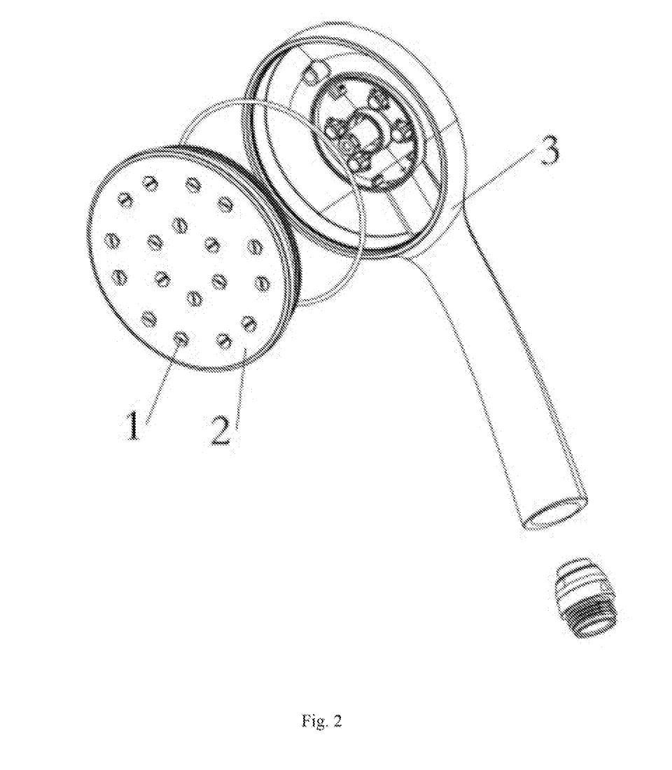

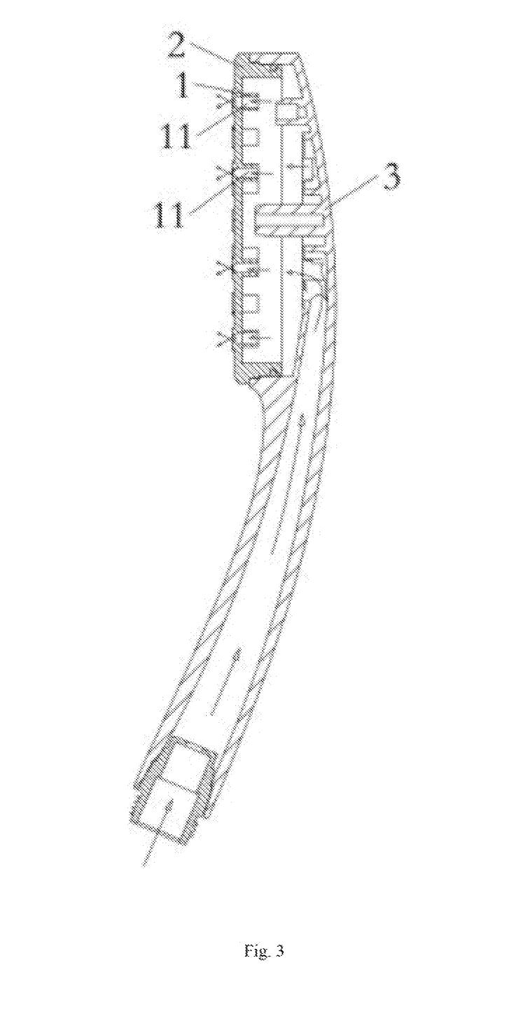

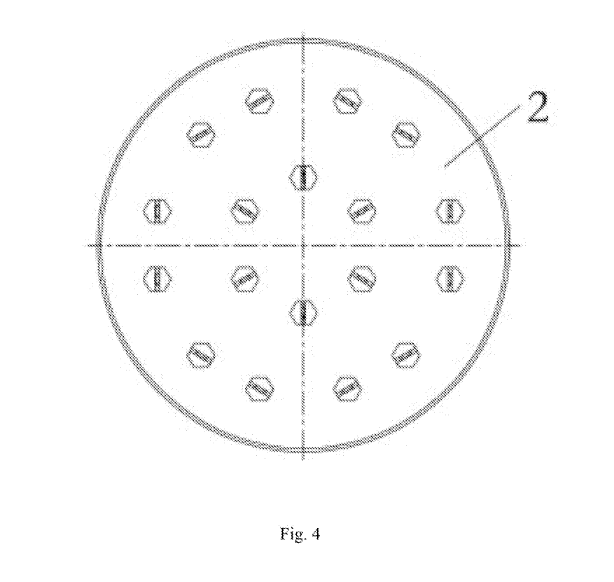

Referring to FIGS. 1-4, water outlet structure 1 for generating candle flame shaped water comprises water inlet passage 11 to collect water, hemisphere water chamber 12 formed at the bottom of water inlet passage 11. V shaped through groove 13 set at the bottom of hemisphere water chamber 12, an axis of the V shaped through groove 13 located on an outside of the axis of the water inlet passage 11 and forming fixed angle 14.

In practical use, the fixed angle 14 ranges from 5 to 15 degrees, which can generate better candle flame spray effect.

The water outlet structure of the present invention can be mounted onto various water outlet products like sprinkler, over-head shower or the like. Taking a shower head which mounts the water out let structure for an example, a shower head for generating candle flame shaped water, wherein a surface cover 2 of the shower head is set with water outlet structure 1 for generating candle flame shaped water thereon in a matrix form. The surface cover 2 cooperates with the head body 3, wherein the water inlet passage 11 of the water outlet structure 1 and the surface cover 2 are molded in an integrated structure.

when the shower head works in a normal condition, the water flows are speeded up by the water inlet passage having a water collecting function. The water flows are concentrated and the water pressure is increased due to a mutation when the water flows through the intersection area between the hemisphere water chamber and the V shaped through groove, and by a further angle deviating, a much more intense collision effect is generated inside the channel. After the collision, the water spray onto the users' body, a larger area showering and more intense impact force and particle feeling are achieved. At the same time, the same effect is achieved by using much less water with above structure, which saves much water to some extent.

The above description merely describes the preferred embodiment of the present invention, and does not intend to limit the scope of the present invention. Those skilled in the art should understand that equivalent replacement or modifications can be made based on the principles of the present invention. However, all such modifications and replacement without departing from the principle shall fall within the scope of the present invention.

1. A water outlet structure for generating candle flame shaped water, comprising:
a water inlet passage for collecting water;
a hemisphere water chamber formed at the bottom of the water inlet passage; and
a V shaped through groove set at the bottom of the hemisphere water chamber;
wherein an axis of the V shaped through groove is located on an outside of the axis of the water inlet passage and forms a fixed angle.

2. The water outlet structure for generating candle flame shaped water of claim wherein the fixed angle ranges from 5 to 15 degrees.

3. A shower head for generating candle flame shaped water, wherein a surface cover of the shower head is set with the water outlet structure for generating candle flame shaped water of claim 1 thereon in a matrix form.

4. The shower head for generating candle flame shaped water of claim 3, further comprising:
a head body;
the surface cover cooperated with the head body;
wherein the water inlet passage of the water outlet structure and the surface cover are an integrated structure.
